(19) United States
(12) Patent Application Publication
(10) Pub. No.: US 2026/0297776 A1
(43) Pub. Date: Oct. 1, 2026

(54) METHOD FOR CONTROLLING A PLANT CONTAINING A PLURALITY OF ELECTROLYSERS

(71) Applicant: JOHN COCKERILL HYDROGEN BELGIUM, Seraing (BE)

(72) Inventors: Nicolas Balczunas, Seraing (BE); Sebastien Borguet, Seraing (BE); Armand Gering, Seraing (BE); Philippe D'Antuono, Seraing (BE)

(73) Assignee: JOHN COCKERILL HYDROGEN BELGIUM, Seraing (BE)

(21) Appl. No.: 19/475,847

(22) PCT Filed: Apr. 19, 2024
(86) PCT No.: PCT/EP2024/060832

§ 371 Date: Oct. 16, 2025

(30) Foreign Application Priority Data
Apr. 20, 2023 (FR) FR2303991

(51) Int. Cl. C25B 15/02; C25B 1/04; C25B 9/70

(52) U.S. Cl. CPC C25B 15/02; C25B 9/70; C25B 1/04

(57) ABSTRACT

A method for controlling a facility containing electrolysers that are fluidically in parallel, including controlling the electrolysers in such a way as to seek to increase the uniformity of the individual loads on the electrolysers in operation. As s a result, specific electrical consumption of the facility for a predetermined total production load or for an electrical power available to power the facility is provided.

The present invention relates to the field of dihydrogen and dioxygen production.

### BACKGROUND OF THE INVENTION

Tackling global warming has forced authorities and manufacturers to rethink the supply of energy to our societies with a view to substituting fossil energy with energy releasing less carbon dioxide, notably in the field of transport for powering vehicles but also for manufacturing fertilizers and steel, not to mention for energy storage and generally for decarbonizing industrial processes using fossil fuels. The need to reduce the production of greenhouse gases and to use renewable energy is now well known. Dihydrogen is an alternative to hydrocarbons because it is an easily storable energy vector, unlike electricity, and its oxidation releases a very high amount of energy (285 KJ/mol).

Several methods exist for producing dihydrogen. The most advantageous involves water molecule electrolysis as it is a high efficiency reaction that does not directly produce CO2, unlike the widely used methods involving reforming methane, coal and hydrocarbons.

Three large types of electrolyzers for water electrolysis are well known in the prior art:
alkaline electrolyzers (AWE), which are characterized by the use of a liquid electrolyte that allows hydroxyl ions (OH—) to be transferred from the cathode to the anode;
high-temperature electrolyzers, the electrolyte of which is a ceramic; and
membrane electrolyzers (PEM), the electrolyte of which is a proton conduction ion exchange membrane. In the three cases, the system must be supplied with water with very high purity (supplying, in the case of alkaline electrolyzers, an electrolytic solution of sodium hydroxide (NaOH) or potassium hydroxide (KOH)). Throughout the remainder of the description, for the sake of conciseness, reference will be made to an alkaline electrolyzer, but it is clearly understood that the present invention also applies to the membrane electrolyzer (for example, a proton exchange membrane).

According to the well known method of the prior art, an electrolytic solution (commonly referred to as lye) is fed into a set of electrolytic cells (known as an electrolyzer stack) via a specific inlet. The electrolytic solution passes through the electrolyzer stack. The water is decomposed into gaseous molecules of dihydrogen H2 in the cathode and of dioxygen 02 in the anode. A diaphragm generally separates the anode from the cathode such that, under normal conditions, the dihydrogen and the dioxygen do not mix. The plant includes an outlet for the dihydrogen and the electrolyte circulating on the cathode (catholyte) side and an outlet for the dioxygen and the electrolyte circulating on the anode (anolyte) side. In other words, there are two distinct streams such that there is a gas-liquid separator dedicated to separating the dihydrogen from the catholyte, and a gas-liquid separator for separating the dioxygen from the anolyte. The liquid outlets of the two gas-liquid separators are then mixed before again feeding the electrolyzer stack. In both streams, at the outlet of the electrolyzer stack, the liquid phase (lye) is loaded as gas bubbles. At the gas-liquid separator outlet, no more than a few gas bubbles remain in the lye discharged through the lower port of the gas-liquid separator dedicated to the liquid phase, while the majority gas phase is extracted from the gas-liquid separator through the upper port of the gas-liquid separator. For various reasons, it is important for the gas to be separated from the lye. Firstly, the more the gas is separated from the electrolyte, the greater the gas production, which contributes to the good electrochemical efficiency of the method. Then, the H2/O2 mixture is highly explosive. If the separation is not performed correctly, a significant amount of gas, commonly called “residual gas”, is conveyed to the liquid outlet of the gas-liquid separator. The next time this gas circulates through the electrolyzer stack (the electrolyte moves in a closed loop) some of this gas passes into the other compartment and therefore on the wrong side.

It is understood that the advantage, both economical and ecological, of using hydrogen in an energy process largely depends on the performance capabilities of the hydrogen production device.

Ideally, the following is necessary:
the manufacturing and operating costs of the production device are as low as possible;
the impact on the natural resources for manufacturing and operating the production device is limited;
the device produces only a limited amount of or no polluting emissions during the operation thereof;
the device is simple, efficient, reliable and relatively compact, etc.

Moreover, the energy efficiency of the plant is not the only challenge when considering the operating costs. Indeed, aims
of flexibility/responsiveness of. adapting to a rapid variation in the demand for dihydrogen production;
and of maintainability

are also crucial for these plants that often comprise a plurality of electrolyzers operating on the same production site and/or that are controlled in a centralized manner. Finally, the ability to maximize the electrical energy consumption for a given production of dihydrogen can paradoxically prove to be advantageous under certain circumstances, notably in terms of a service for regulating the electrical network (which may or may not be local).

### AIM OF THE INVENTION

Notably, the aim of the invention is to improve all or some of the energy aspects Of a plant containing a plurality of electrolyzers.

### SUMMARY OF THE INVENTION

To this end, a method is provided, according to the invention, for optimizing the control of a plant containing a plurality of parallel electrolyzers (called “MIEL-S” hereafter).

The essential feature of the method of the invention is that the control is implemented in order to homogenize the individual loads of the operating electrolyzers, while tending to minimize the specific consumption of the plant for a predetermined total dihydrogen production load or for an availability of an electrical power supply for the plant.

It is under these conditions that the plant can achieve optimal efficiency while promoting the responsiveness and the flexibility of the whole and also while taking into account the constraints in terms of the availabilities of the electrolyzers (referred to as “ELY” throughout the remainder of the document) with respect to, for example, the maintenance program of the plant. The invention also allows a strategy to be used for maximizing the electrical power consumed by the “MIEL-S” for a given dihydrogen production level in order to maximize the range of regulation of electrical power absorbed within the context of service for regulating the electrical network (which may or may not be local).

Further features and advantages of the invention will become apparent upon reading the following description of particular and non-limiting embodiments of the invention.

### BRIEF DESCRIPTION OF THE DRAWINGS

Let “MIEL-S” (Multi Identical Electrolyzer System) be a set of N a priori identical electrolyzers and be able to operate a number “n” of electrolyzers, with “n” ranging from 0 to N.

Let “HOLOS(n)” (Homogenous Load Operation Strategy) be a strategy involving homogenously distributing the load within the “n” operating electrolyzers.

Reference will be made to the accompanying drawings, in which:

FIG. 1 is a characteristic curve of the specific individual consumption of one of the multiple identical electrolyzers of the MIEL-S;

FIG. 2 shows an array of N HOLOS curves. Each curve of the graph is associated with a number “n”, with n in this case being equal to a value ranging between 1 and N electrolyzers operating within the “MIEL-S” system that includes a total of N electrolyzers. The n operating electrolyzers follow a “HOLOS” strategy and the N-n other electrolyzers of the MIEL-S system for their part are shutdown (or on standby). The array of curves therefore shows the specific consumption (kWh/Nm³) of the MIEL-S as a function of the system load and of the number “n” of operating electrolyzers, considering that the operation strategy is always of the HOLOS type irrespective of the number “n”. A HOLOS type strategy will always be modeled on this array of curves. An operation strategy that is not modeled on this array of curves is not of the HOLOS type;

FIG. 3 is similar to FIG. 2 and shows the intersections of the curves with each other. These intersection points are called “HOLOS points”. There are 2*N intersection points. These HOLOS points are numbered from 1 to 2*N in order of occurrence during an increase in load of the MIEL-S system;

FIG. 4 is similar to FIG. 2 and shows the best efficiency curve (BEL=Best Efficiency Line) of an MIEL-S;

FIG. 5 is a graph showing the position of the 2*N “HOLOS points” on the specific individual consumption feature of the multiple identical electrolyzers of the MIEL-S;

FIG. 6 is a graph that shows the evolution of the load of the electrolyzers within the MIEL-S during occurrences of the 2*N HOLOS points;

FIG. 7 is a graph that shows the ratio of loads relative to consecutive HOLOS points during a monotone increase in load of the MIEL-S;

FIG. 8 is similar to FIG. 2 and shows the best efficiency curve (BEL) for electrolyzers that are considered to be “invisible” per group of four in terms of load;

FIG. 9 is similar to FIG. 4 and shows the worst efficiency curve (WEL=Worst Efficiency Line) that does not follow a HOLOS type strategy. Its advantage, within a context of a service for regulating the electrical network (which may or may not be local), is to identify the upper limit of electrical energy that the MIEL-S can consume for a given dihydrogen production;

FIG. 10 is similar to FIG. 9 and shows the worst efficiency curve (HOLOS-WEL type) within the context of the HOLOS strategy;

FIG. 11 is similar to FIG. 9 and shows the curve minimizing the number of operating electrolyzers (T LEO L=The Less Electrolyzer in Operation Line) for a given load of the MIEL-S and aiming to maintain a HOLOS type strategy;

FIG. 12 is similar to FIG. 9 and shows the curve maximizing the number of operating electrolyzers (T MEO L) for a given load of the MIEL-S and aiming to maintain a HOLOS type strategy;

FIG. 13 shows the number of operating electrolyzers as a function of the load of the MIEL-S and does so for the various HOLOS strategies mentioned above;

FIG. 14 shows an example of a desired production curve for dihydrogen for the plant as a function of time and of the load of the plant;

FIG. 15 is similar to FIG. 14 and also shows the response curve in terms of the number of operating electrolyzers when the strategy that is followed is of the “BEL” type;

FIG. 16 is similar to FIG. 14 and also shows the response curve in terms of specific consumption when the strategy that is followed is of the “BEL” type;

FIG. 17 is similar to FIG. 14 and also shows the response curve in terms of power consumed by the plant when the strategy that is followed is of the “BEL” type.

It should be noted that the values are mentioned by way of an indication in order to provide orders of magnitude and also depend on the configurations of the equipment forming the electrolyzers.

The same is true for the time scales, which are also mentioned by way of an indication.

### DETAILED DESCRIPTION OF THE INVENTION

By way of an example, the multi-electrolyzer plant or system (MIEL-S or “Multi Identical Electrolyzer System”) in this case is made up of N=24 1,000 Nm³/h identical electrolyzers (ELY) that are connected fluidically parallel, each is assumed to be fully independent in terms of production load. The invention is obviously applicable to any other nominal capacity of the electrolyzers (typically from 1 Nm³/h to 4,000 Nm³/h, in particular between 100 Nm³/h and 2,000 Nm³/h, in particular from 500Nm³/h to 1,500Nm³/h).

Optimizing the control of a multi-electrolyzer plant is not trivial and needs to be conceptually constructed step by step.

The first part of the present description discloses a methodology for establishing various operation strategies of an MIEL-S responding, for example, to the following questions:
how to distribute the production load within an MIEL-S?
at which production load should an ELY within an MIEL-S be shutdown or started-up?
does the response to these first two questions change as a function of the intended aim, such as:
   minimizing the energy consumption required for producing dihydrogen;
   maximizing responsiveness in terms of production load variation;
   increasing the maintainability of the system; or
   minimizing the degradation of the energy performance capabilities of the system?

This methodology also allows the operator of an MIEL-S (or its designer), knowing the properties of the plants (specific consumption as a function of the load, shutdown/start-up time, degradation rate as a function the operational stresses, etc.), to arbitrate between the various operation strategies and to identify that which will be most suitable for their operating context.

This first part is based on an idealized approach to reality, only taking into account the theoretical behavior of the plant at the beginning of life (BOL) in order to define a strategy for optimizing the control thereof.

The second part of the present description is intended to complete this approach with “non-ideal” phenomena such as, for example, the incidence of performance degradation over time on optimizing control.

The initial hypothesis is that the demand for dihydrogen production load is well known over a time horizon T and that the problem to be solved is to minimize the specific electrical consumption of the plant (specific consumption Cs [kwh/Nm3]) given this production load on this time horizon T.

### 1. Idealized Approach

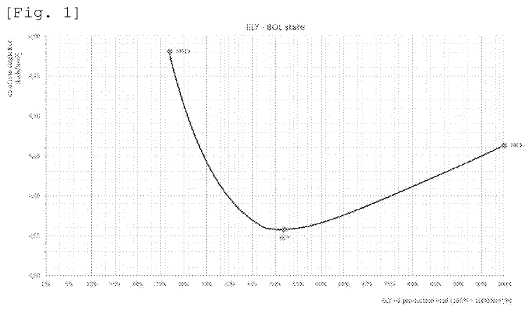

a. Critical Points of an Efficiency Curve of an Electrolyzer (see FIG. 1)

Three characteristic points are to be noted on the specific consumption curve, Cs, of the ELY:
MCR or “maximum continuous rate”. Let, in the example of FIG. 1, there be 100% load (equivalent to nominal production of 1,000 Nm³/h, for example) for a Cs of 4.66 kwh/Nm³;
BEP or “best efficiency point”. Let there be 52% load for a Cs of 4.56 kwh/Nm³ in the example of FIG. 1. The specific consumption curve effectively passes through a minimum (BEP) that results from the adversarial phenomena inside the electrolyzer stack when the current density thereof varies;
MSOL or “minimum stable operating point”. In FIG. 1, the minimum stable operating point is at 27% of the dihydrogen production load.
   b. Best Efficiency Line (BEL)—Optimizing the Operation of an MIEL-S Plant

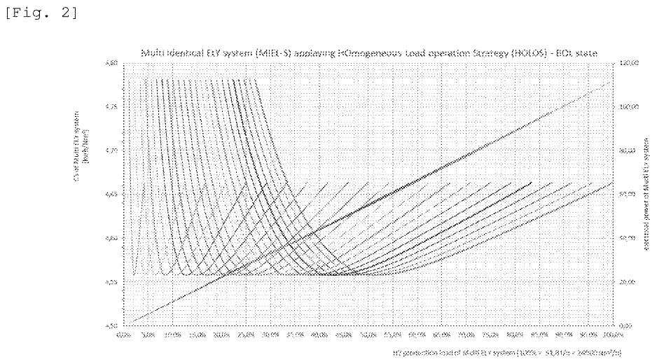

Given the concavity of the curvature (second positive drift) of the curve Cs of FIG. 1 mentioned above, a system operating with a plurality of ELY and having to encounter a given load will always minimize its specific consumption by homogenizing the individual production load of each ELY within the system as much as possible. In the example of a plant described herein, it is considered that the twenty-four ELYs each operate at 70% of their load, the plant will then be at 70 % of its total capacity (or load). The specific Consumption of the plant would then be (see FIG. 2, left-hand scale) approximately 4.59 kwh/Nm³. It is possible to contemplate downwardly varying the individual load of one of the twenty-four ELYs and keeping the total load of the plant unchanged by varying another one of the twenty-four ELYs according to the same proportions. The result would not be as good in terms of the specific consumption of the plant.

This defines a first optimization strategy, called HOLOS (HOmogenous Load Operation Strategy), by homogenizing the operating load, by considering, for the sake of simplification, that all the electrolyzers at all times have the same specific consumption curve.

This strategy is based on the principle that, for a given number of ELYs operating out of the twenty-four that make up the plant (MIEL-S), these will minimize the electrical consumption of the plant for a given total production load, yet while all being at the same individual production load. Furthermore, twenty-four specific consumption curves are considered in FIG. 2. They are all of the HOLOS type. The first of which, as mentioned above, relates to the case whereby the twenty-four ELYs are operating. The twenty-three other curves correspond to 23, 22, 21, . . . , 3, 2, 1ELY that therefore operate according to a HOLOS strategy (i.e., the individual loads of the operating electrolyzers are identical to each other).

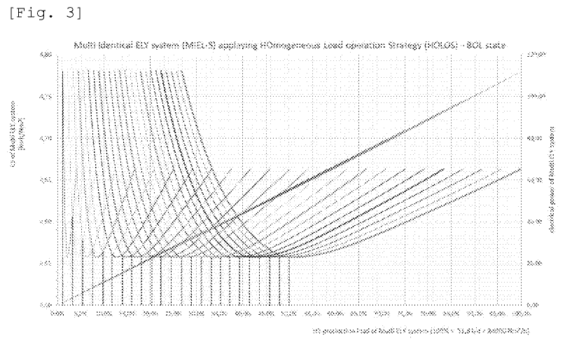

The next step involves defining when to shutdown or start-up an ELY when the load of the MIEL-S plant varies. This is the aim of FIG. 3, which shows the intersections of the HOLOS curves (24) with HOLOS (23); HOLOS (23) with HOLOS (22); . . . ; HOLOS (2) with HOLOS (1). The production loads at said intersections (HOLOS points) are actually the production load percentages of the plant (MIEL-S) at which it is theoretically worthwhile varying the number of operating ELYs in order to minimize the specific consumption of the system.

This optimization does not take into account, at this stage, the penalty that the MIEL-S plant experiences in terms of future performance degradation, or the performance variations within the same batch due to manufacturing tolerances. This “non-ideal” aspect will be dealt with in the dedicated section of this description.

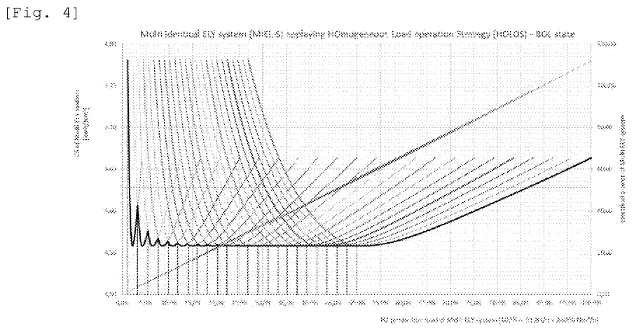

Starting therefrom, it is possible to plot the BEL envelope curve of the MIEL-S. This is shown in FIG. 4 and constitutes a lower limit of the specific consumption of the plant (MIEL-S). In other words, the BEL envelope curve defines the lower limit of all the specific consumption curves. Although this line appears to describe a plateau (in particular between 25% and 50% of the load in the example considered herein), it actually passes through twenty-four minima, all equal and corresponding to the BEP defined above.

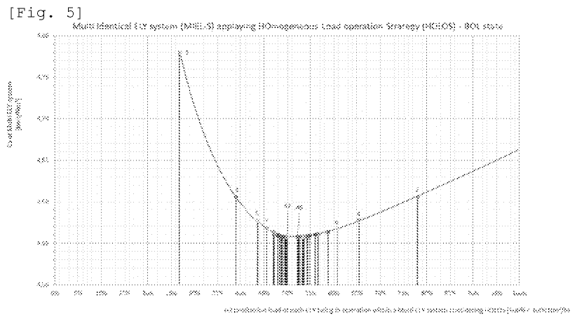

The individual loads of the ELYs of the plant when the number of operating ELYs evolves for the plant are shown in FIG. 5. The chronology of the numbers used on the graph corresponds to an increase in the load of the MIEL-S plant, starting with an ELY operating at MSOL (point 1). The load of this ELY rises, following the curve Cs to point 2, which is when a second ELY must be started-up in order to minimize the specific consumption Cs, while continuing to increase the load of the plant (MIEL-S). In doing so, the individual load of the two ELYs is “instantaneously” positioned at point 3. The individual loads thus continue to evolve toward points 4, 5, 6, 7, . . . , 46, 47. These points are referred to as “HOLOS points” hereafter. For the sake of simplification, the start-up/load increase times of each additional electrolyzer are disregarded in this case: it is a steady state static optimization.

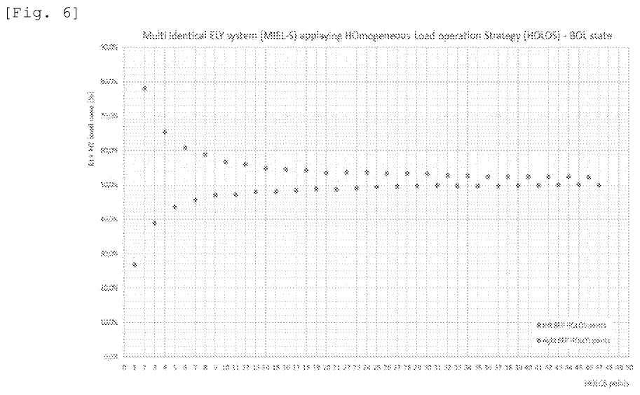

The graph of FIG. 6 shows the evolution of the “HOLOS points” located “to the left and to the right” of the BEP.

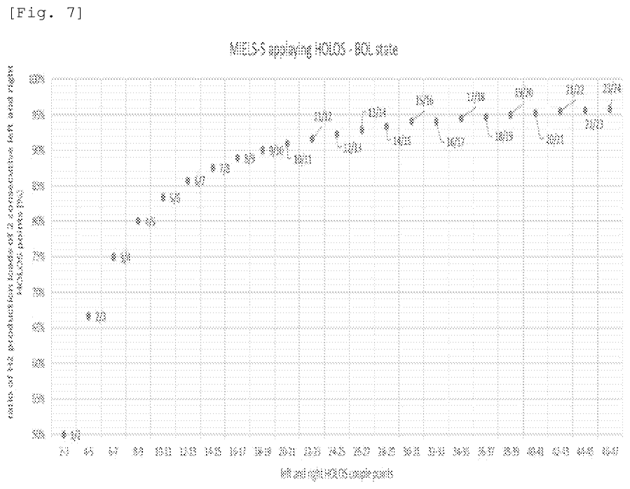

The ratio of individual loads of the consecutive HOLOS points (immediately before and immediately after the change in the number of operating ELYs) complies with a logic sequence illustrated in the graph of FIG. 7.

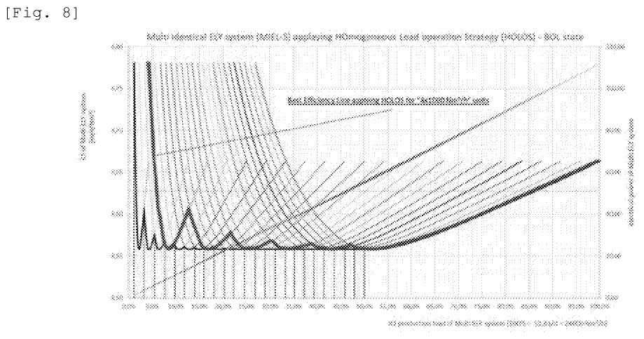

If the MIEL-S plant had to have integral ELYs arranged four-by-four in terms of load (for example, considering six ELY4000 instead of twenty-four ELY1000), the BEL would evolve as shown by the graph of FIG. 8 (considering the red line and not the black line).

c. Worst Efficiency Line (WEL) of an MIEL-S Plant

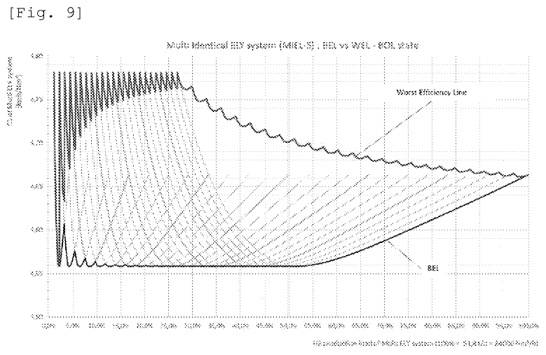

In FIG. 9, the worst efficiency line WEL (in red) is plotted in addition to the best efficiency line BEL (in black) in order to show the maximum improvement potential allowed by attempting to approach the best efficiency line BEL. Also, the difference between these two curves, for a given dihydrogen production, is the image of the electric power variation lever consumed by the MIEL-S. This notion is useful within the context of a service for regulating the electrical network, whether or not said network is local.

The WEL corresponds to a two-phase implementation.

Considering a monotone reduction in load and starting from an initial situation whereby the MIEL_S is at full load (with all the ELYs being at 100% load), during phase 1, the load reduction is organized as follows: a number i (with i ranging from N−1 to 0) of ELYs at 100%, a number equal to N−1−1 of ELYs at MSOL and an ELY adjusting the load of the plant with its own load. When this ELY reaches MSOL, i becomes i-1 and one of the ELYs operating at 100% load starts regulating, alone in turn, the load of the MIEL-S. Phase 1 results in a final situation whereby the N ELYs are all at MSOL.

Phase 2 therefore starts with an initial situation that is the final situation of phase 1, namely, all the N ELYs at MSOL. During phase 2, the continuation of the load reduction is managed as follows: a number j (with j ranging from N−2 to 0) of ELYs at MSOL, a number equal to N−j−1 of ELYs are shutdown (or on standby) and an ELY adjusts the load of the plant with its own load. When this ELY reaches MSOL, it is shutdown (or put on standby), and j becomes j−1. Phase 2 results in a final situation whereby the N ELYs are all shutdown (or on standby).

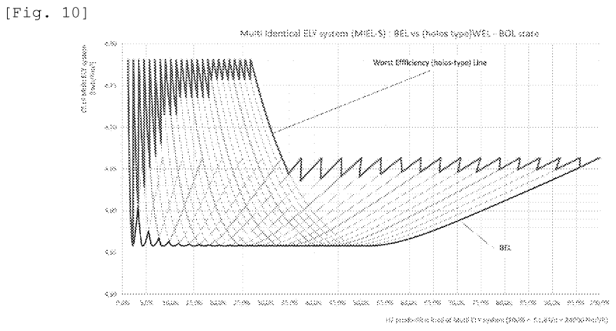

The graph of FIG. 10 shows a voluntarily degraded alternative of the best efficiency line: the “Worst Efficiency Line-HOLOS”. Although this alternative always considers a HOLOS approach, it nevertheless disregards the “HOLOS points” defined above. Indeed, considering, for example, the case of a monotone load reduction and starting from the case of twenty-four ELYs at 100% load, the strategy followed involves shutting down the ELYs as soon as possible, one by one, thus allowing the other ELYs to operate at a relatively high individual load, and to do so permanently. After a certain number K of ELYs (with K being fifteen in the defined listed example) is shutdown and the load of the N-K (with N-K being nine in the described listed example) other ELYs that are still operating is reduced, a second phase of this strategy involves, when the load of the plant is low enough to cross the HOLOS curve (N), restarting all the N (with N being twenty-four) ELYs so that they all operate at a very low individual load, where the specific individual consumptions are not as good. The remainder of the illustration also considers shutting down the ELYs one by one until the situation is reached whereby only one ELY is operating and descends to its MSOL.

The use of the WEL and WEL HOLOS strategies results in a lack of relative optimization that increases as the load of the plant decreases.

d. HOLOS Line of the Minimum Number of Operating Electrolyzers (T LEO L=The Less Electrolyzer in Operation Line) of an MIEL-S Plant

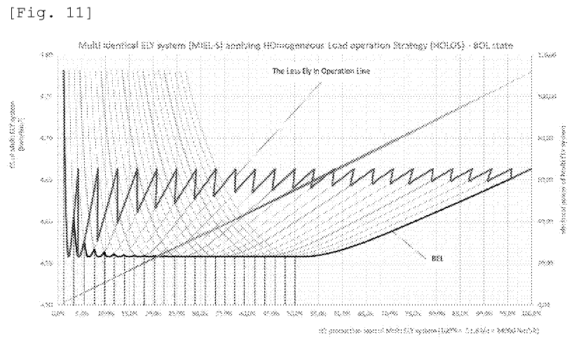

This strategy, illustrated in FIG. 11, involves shutting down an ELY as soon as possible once this is allowed by the total production load of the MIEL-S plant, while enrolling in a HOLOS strategy. The number of simultaneously operating electrolyzers is therefore reduced to the minimum number required to provide the total production load of dihydrogen: as a result, the individual load of the operating electrolyzers is instead relatively high even when the total production load is relatively low. The primary optimization aim relates to the number of electrolyzers and the specific consumption is a secondary aim.

This strategy is preferably used during the maintenance operations of the plant that require shutting down the largest possible number of ELYs or in the event that a rapid reduction in a total production load is required.

e. HOLOS Line of the Maximum Number of Operating Electrolyzers (T MEO L=The More Electrolyzer in Operation Line) of an MIEL-S Plant

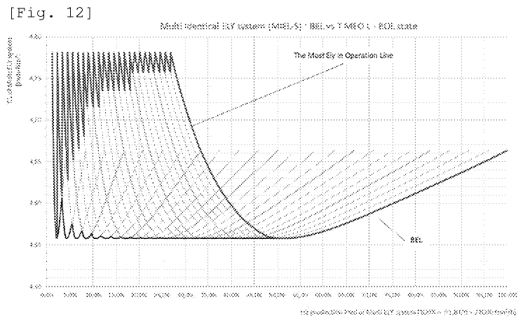

This strategy, which is illustrated in FIG. 12, involves, during a monotone reduction in the load of the MIEL-S, keeping a maximum possible number of ELYs in operation, while enrolling in a HOLOS strategy. When the load falls below the load threshold corresponding to N ELYs at MSOL, an ELY is shutdown (or put on standby) and the MIEL-S then evolves to HOLOS (N−1). The progress of the load reduction is managed in the same way by successively passing from HOLOS (N−1) to HOLOS (N−(1+1)) (with 1 ranging from 0 to N−2). When the load results in MSOL on HOLOS-1, the last ELY is shutdown (or put on standby) in turn. The result of this strategy is that the individual load of the operating electrolyzers is instead relatively low when the total production load is low.

This strategy can be used throughout the lifetime of the plant, for example, to mitigate the performance degradation related to the individual load rate of the electrolyzers. Furthermore, this strategy offers the widest operation range without shutting down and starting-up (between 27% and 100%). This range without shutting down/starting-up can be referred to as “SSL” (Start & Stop Less). This SSL range, on the one hand, minimizes performance degradation due to occurrences of start-ups/shutdowns and, on the other hand, maximizes the responsiveness of the system (by virtue of the absence of an ELY shutdown/start-up procedure within the MIEL-S that is costly in terms of operating time) when confronted with load variations that would have resulted in, through other operation strategies, ELY shutdowns/start-ups increasing performance degradation and decreasing the responsiveness of the MIEL-S as a whole. Moreover, this strategy allows the control of the plant and its operation to be simplified. It should be noted that it is possible to generalize the notion of T MEO L as follows. The case that has just been described considers the initial situation “HOLOS(N)” (in this case “HOLOS(24)”). The resulting SSL range can be accurately referred to as SSL(N) (in this case “SSL(24)”). It then can be seen that this strategy can be specifically denoted T_MEO_L(N). For a given MIEL-S, it is quite possible to contemplate noting that during a given period the load will often vary, mainly in a range “P” not included in the SSL(N) range. It then will be entirely possible to optimize the choice of another T MEO L(m) (with m<N) that would lead to the range P being better included in the SSL(m) thus generated by this choice of operation strategy. In other words, the electrolyzers are controlled to operate a maximum number m of electrolyzers at their optimal operating point that is less than the total number N of electrolyzers, with the maximum number m corresponding to a load of the plant varying within an operating range that is less than a maximum operating range of the plant using the total number of electrolyzers.

f. Managing the Load of an MIEL-S Plant

The load of the plant can be managed according to a first approach based on the production of dihydrogen or according to a second approach based on the availability of the electrical power supplying the plant. The description in the present document assumes the first approach. Indeed, according to the graph of FIG. 1, the ordinate is expressed as a function of the dihydrogen production load. All the graphs and operation strategies described hereafter are thus expressed as a function of the dihydrogen production load. In order to contemplate the second approach, the same arguments as those set forth for the first approach simply need to be reproduced, starting from an alternative to the graph of FIG. 1, by expressing “the evolution of the specific consumption as a function of the electrical £ load” rather than “the evolution of the specific consumption as a function of the dihydrogen production load”. The graphs are substantially similar in terms of appearance and lead to the same types of arguments and analysis.

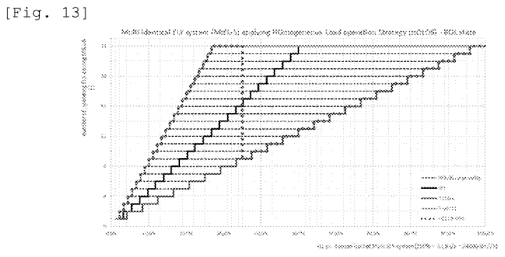

FIG. 13 thereby illustrates the first approach and represents the production of dihydrogen by the MIEL-S plant as a function of the number Of operating ELYs and according to various usable strategies, namely BEL, T LEO L, TMEO L(N), HOLOS WEL.

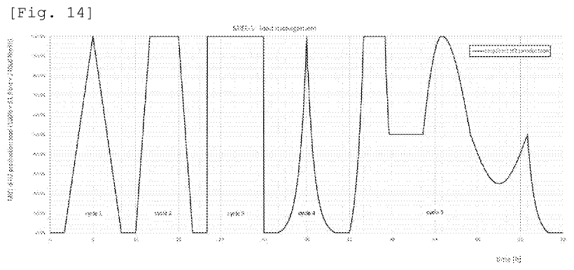

FIG. 14 shows the required dihydrogen production load (thin solid line) in accordance with the first approach (different shaped profiles have been selected to illustrate the adaptation of the production of the plant to these various profiles).

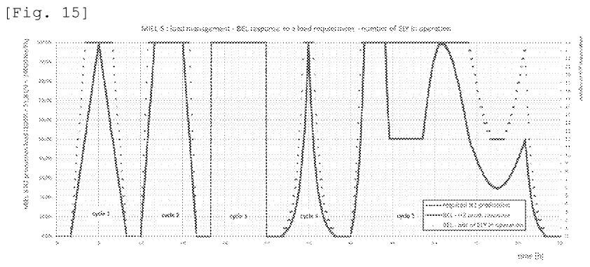

FIG. 15 shows the same required dihydrogen production load (thin dashed line), which has been superimposed by the load produced in response by implementing the BEL strategy (thick red solid line) and the number of operating ELYs (thick blue discontinuous line).

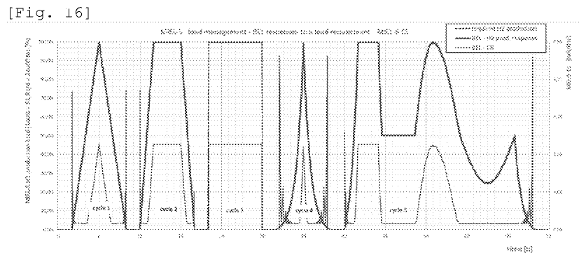

FIG. 16 shows the same required dihydrogen production load (thin dashed line), which has been superimposed by the load produced in response by implementing the BEL strategy (thick solid line) and the specific consumption Cs of this strategy (thin blue solid line).

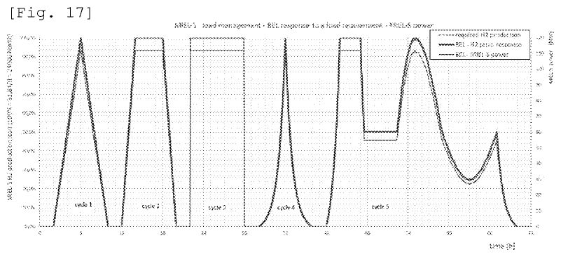

FIG. 17 shows the required dihydrogen production load (thin dashed line), which has been superimposed by the load produced in response by implementing the BEL strategy (thick solid line) and the power of the MIEL-S plant (thin blue solid line).

### 2. Consideration of Non-Ideal Phenomena

a. List of “Non-Ideal” Phenomena Influencing the Optimization of Load Management of the MIEL-S Plant
limiting the operating range (% dihydrogen production load) related to certain components of the plant (including inside the ELYs when pooling multiple ELYS);
degradation of the performance capabilities related to the shutdowns and start-ups of the ELYS;
degradation of the performance capabilities related to the operating hours of the ELYs;
shutdown and start-up times of the ELYs, as well as any energy losses during transitions;
a performance imbalance between the ELYs of the electrolyzer stack (the electrolyzers theoretically are all identical but in reality their performance capabilities are different)
a dynamic requirement for load absorption or reduction for the MIEL-S plant based on the forecast for the production demand;
total or partial unavailability of one or more ELYs;
the occurrence of an emergency stop.
   b. Consideration of “Non-Ideal” Phenomena Influencing the Optimization of Load Management of the MIEL-S Plant

In general, the answer to the question, “at which load of the plant should the ELYs within a multi-ELY system (MIEL-S) be shutdown or started-up?”, given these “non-ideal” phenomena, will depend on the forecast of the future load and on the remaining service life of the plant.

Indeed, bearing in mind, for example, that each shutdown of an ELY involves a degradation of its future performance capabilities, is it necessary, during operation and facing an increase in the demand for dihydrogen production:
to start-up an additional ELY to decrease the average load of the ELYs and thereby decrease the energy consumption of the plant in the short term, while at the same time being notified that this load, which up to now is increasing, is about to decrease and that the ELY that has just been started-up will have to be shutdown soon?; or
on the contrary, to tolerate an optimization defect in the short term in order to preserve the performance capabilities of the plant in the longer term?

The answer to this question will not necessarily be the same depending on when it is posed during the service life of the plant. This involves the notion of LCOH and its continuous re-computation based on the short- and long-term load forecasts.

Thus, the optimization of the efficiency of a plant can be obtained by, separately or all or partly in combination:
individually homogenizing the ELYS;
operating a maximum number of ELYs at their optimal operating point;
dynamically determining the load of each ELY individually based on its particular specific efficiency (related to its specific aging, its specific capability, etc.);
adapting the individual capacities of the plant in order to refine the load or production capacity and to optimize the efficiency of the plant.

Of course, the invention is not limited to the embodiment described but covers any variant falling within the scope of the invention as defined by the claims.

In particular, the numerical values are only indicated by way of an example.

The specific consumption Cs and dihydrogen production values are valid for electrolyzers at their maximum operating limit, taking into account energy losses (electrolyzer stack, rectifier, transformer, gas-liquid separator, purifier, pump, etc.) and dihydrogen losses in the gas-liquid separation and purification units.

The normal cubic meter is considered at 0° C. and 1 atm.

The number of electrolyzers can be less than or greater than twenty-four.

The actual operating parameters are determined by monitoring the plant or by a statistical analysis of existing plants.

Each electrolyzer can be equipped with its own power conversion device (rectifier). In another case, at least two stacks can be electrically connected in series (addition of voltage).

The method can include a step of defining a worst efficiency mode in which the load for the plant is adjusted by acting on the load of only one of the electrolyzers, with the other electrolyzers either being at their maximum load or at their minimum operating point or being shutdown; and a step of controlling the plant between an optimal mode corresponding to homogenizing the individual loads of the operating electrolyzers and the worst efficiency mode.

It should be noted that the curve, Cs versus load, preferably represents the complete plant (therefore including the 'Balance Of Plant') rather than that only representing the electrolyzer stack (and some of its loss mechanisms), since the end user is interested in the overall consumption (i.e., including the BOP).

1. A method for controlling a plant containing a plurality of electrolyzers that are fluidically parallel, comprising controlling the electrolyzers by seeking to homogenize individual loads of the operating electrolyzers in order to minimize a specific electrical consumption of the plant for a predetermined total production load or for an electrical power available for powering the plant.

2. The method as claimed in claim 1, further comprising determining specific consumption curves each corresponding to a number n of operating electrolyzers, with the number n varying from 1 to N, which is the total number of electrolyzers for the plant.

3. The method as claimed in claim 2. further comprising determining an envelope curve representing a lower limit of the set of specific consumption curves.

4. The method as claimed in claim 3, wherein the number of electrolyzers to simultaneously keep operating is determined based on the envelope curve.

5. The method as claimed in claim 4, further comprising reducing the number of simultaneously operating electrolyzers to a minimum number required to provide the total production load.

6. The method as claimed in claim 4, further comprising increasing the number of simultaneously operating electrolyzers to a maximum number required to provide the total production load.

7. The method as claimed in claim 1, wherein a theoretical mode for controlling the plant is initially determined based on the status of the plant at the beginning of its service life and then the theoretical mode for controlling the plant is modified as a function of at least one actual operating parameter of the plant.

8. The method as claimed in claim 7, wherein the actual operating parameter belongs to the following group of parameters:
limiting an operating range of at least one component of the plant;
a performance degradation related to the shutdown and start-up cycle of the electrolyzers;
a performance degradation related to an operating time of the electrolyzers;
a shutdown and start-up times of the electrolyzers and energy losses during the transitional phase between the shutdown and start-up of the electrolyzers;
a performance imbalance between the electrolyzers;
a dynamic requirement for load absorption or reduction for the plant based on a production demand forecast;
total or partial unavailability of at least one electrolyzer; and
the occurrence of an emergency stop of all or some of the plant.

9. The method as claimed in claim 7, wherein the actual operating parameter is determined by monitoring the plant or by a statistical analysis of existing plants.

10. The method as claimed in claim 1, further comprising controlling the electrolyzers to operate a maximum number of electrolyzers at their optimal operating point.

11. The method as claimed in claim 1, further comprising controlling the electrolyzers to operate a maximum number of electrolyzers at their optimal operating point that is less than the total number of electrolyzers, with the maximum number corresponding to a load of the plant varying within an operating range that is less than a maximum operating range of the plant using the total number of electrolyzers.

12. The method as claimed in claim 1, further comprising dynamically determining the individual load of each electrolyzer based on its particular specific efficiency.

13. The method as claimed in claim 1, further comprising defining a worst efficiency mode in which the load for the plant is adjusted by acting on the load of only one of the electrolyzers, with the other electrolyzers either being at their maximum load or at their minimum operating point or being shutdown.

14. The method as claimed in claim 13, further comprising controlling the plant between an optimal mode corresponding to homogenizing the individual loads of the operating electrolyzers and the worst efficiency mode.

15. The method as claimed in claim 8, wherein the actual operating parameter is determined by monitoring the plant or by a statistical analysis of existing plants.
